(19) United States
(12) Patent Application Publication
(10) Pub. No.: US 2005/0013949 A1
(43) Pub. Date: Jan. 20, 2005

(54) Ink-jet recording sheet

(75) Inventors: Masayuki Ushiku, Yokohama-shi (JP); Yoshinori Tsubaki, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Holdings, Inc., Tokyo (JP)

(21) Appl. No.: 10/886,433

(22) Filed: Jul. 7, 2004

(30) Foreign Application Priority Data
Jul. 15, 2003 (JP) JP2003-197058

(51) Int. Cl. B41M 5/00

(52) U.S. Cl. 428/32.34

(57) ABSTRACT

An ink-jet recording sheet containing a support having thereon an ink receptive layer containing silica microparticles made by a gas-phase method and a hydrophilic binder, wherein the ink-jet recording sheet has two Bristow test measurements Va and Vb which satisfy the following formula: Vb≧10 ml; and Vb/Va≧0.7, Va and Vb are separate Bristow test measurements of an amount of water absorbed by the ink-jet recording sheet when the ink-jet recording sheet is contacted with water for 0.02 seconds, Va being measured before treatment of the ink-jet recording sheet, and Vb being measured after treatment of the ink-jet recording sheet, the treatment being: (i) immersing the ink-jet recording sheet in water for 15 seconds; and then (ii) drying the ink-jet recording sheet such that the ink-jet recording sheet has a weight increase of less than 1 weight %.

### TECHNICAL FIELD

The present invention relates to an ink-jet recording sheet capable of giving a high quality image having high glossiness without occurrence of speckles and banding on the printed image, and the resistivity to outdoor conditions of the paper itself is excellent.

### BACKGROUND

In the ink-jet recording, minute ink droplets are ejected by various principles and adhered to a recording sheet to record an image or character. This method has many advantages that the images can be formed with relatively high speed with low noise and multiple color images can be easily achieved.

Hitherto, blocking and maintenance of the nozzle have been problems for the ink-jet method. However, these problems are dissolved from both of the aspects of the ink and the apparatus, and the method is rapidly spread in various fields of printer, facsimile machine and computer terminal.

Recently, the image quality is made higher so as to arrive at that of the conventional photography. Therefore, it is required to recording sheet to realize the image quality of the conventional silver slat photograph and to reproduce the feeling of glossiness, smoothness and stiffness of a silver salt photographic image.

As a method for reproducing the feeling of the silver salt photograph, recording sheet so called as swelling type has been known which is composed of paper support and a hydrophobic binder such as gelatin and poly(vinyl alcohol) coated on the support. However, that method has drawbacks that the ink absorbing speed is low, the printed surface tends to be sticky, and the water resistivity of the ink absorptive layer and the image tends to be spread by influence of the humidity. Particularly, the droplets of the inks are mixed before absorbed by the recording sheet surface since the ink absorbing speed of the hydrophilic layer is slow. Consequently, bleeding or spreading of different colors and beading or the unevenness of color in the same color area tend to occur; and the image quality of the silver salt photograph can be difficultly attained.

Porous type becomes as the main stream of the recording sheet in place of the swelling type, which is characterized by fast absorbing speed since the ink is absorbed into minute pores. Many kinds of these papers are disclosed, for example, the later-mentioned Patent Publication 1.

Besides, requirements as to the durability and the storage ability of image are raised, and many attempts have been performed so as to attain the light fastness, humidity resistivity to those of the silver salt photograph, refer, for example, the later-mentioned Patent Publication 2.

The influence of the colorant of the ink on the storage ability of the image is also large; and pigment type colorants are generally superior to the dye type colorants in the storage ability of the resistivity to water and the fastness to light. Consequently, the pigment ink is preferable when the printed matter is posted up under hard conditions of the rain or the sun light of outdoor. When a colorant having high image storage ability is employed under hard conditions, the storage ability of the recording sheet becomes more important problem rather than the storage ability of the colorant itself. For example, when the substrate of the swelling type recording material is paper, it may be raised problems that the ink absorptive layer is dissolved or the support is waved by the rain. In the case of the porous type recording sheet, problems that the cracks are formed or the foaling off of the ink absorptive layer caused by the rain and the sun light tend to occur.

Patent Publication 1: Japanese Patent Publication Open to Public Inspection (hereafter referred to as JP-A) No. 10-119423; Claims and Example 1

Patent Publication 2: JP-A No. 57-87989; P. 2, 1. 17 of left lower column to 1. 7 of right upper column

### SUMMARY

An object of the invention is to provide an ink-jet recording sheet capable of giving a high quality image having high glossiness without occurrence of speckles and banding on the printed image and the resistivity to outdoor conditions of the paper itself is excellent.

An embodiment of the present invention includes an ink-jet recording sheet having a support having thereon an ink receptive layer containing silica microparticles and a hydrophilic binder, wherein the ink-jet recording sheet has two Bristow test measurement values Va and Vb which satisfies a specific formula, Va being obtained without water treatment and Vb being obtained after water treatment prior to Bristow test measurement.

### DESCRIPTION OF THE PREFERRED EMBODIMENTS

The above object of the invention is attained by the following embodiments.

(1) An embodiment of the present invention includes an ink-jet recording sheet including a support having thereon an ink receptive layer containing silica microparticles and a hydrophilic binder,
wherein the ink-jet recording sheet satisfies the following formula:
   Vb≧10 ml; and
   Vb/Va≧0.7,
Va and Vb are separate Bristow test measurements of an amount of water absorbed by the ink-jet recording sheet when the ink-jet recording sheet is contacted with water for 0.02 seconds, Bristow test measurements being values obtained by Bristow's method,
Va being measured before treatment of said ink-jet recording sheet, and Vb being measured after treatment of said ink-jet recording sheet,
said treatment being:
(i) immersing said ink-jet recording sheet in water for 15 seconds; and then
(ii) drying said ink-jet recording sheet such that said ink-jet recording sheet has a weight increase of less than 1 weight %.

(2) Another embodiment of the present invention includes the ink-jet recording sheet of Item 1, wherein the hydrophilic binder is a nonionic polymer which has been hardened by irradiation with ultra violet rays.

(3) Another embodiment of the present invention includes the ink-jet recording sheet of Item 1, wherein the hydrophilic binder is a hydrophilic polymer having a degree of polymerization of 300 to 5000 and having a plurality of side chains bonded to a main chain in the molecule, a cross-linking bond is formed between the sides chains by irradiation with ultra violet rays.

(4) Another embodiment of the present invention includes the ink-jet recording sheet of Item 1,
wherein each of the silica microparticles has an particle diameter of 0.005 to 0.25 μm.

(5) Another embodiment of the present invention includes the ink-jet recording sheet of Item 1,
wherein the support is non water-absorptive.

The present invention is described in detail below.

Bristow's method (or Bristow test method) has been known as a method for measuring the ink absorbing rate and widely applied for evaluation of the ink-jet recording sheet. It is considered that the problems of the speckles and the banding will be caused by association of the droplets when the ink absorbing rate is low. These problems are difficultly raised when the ink absorbing rate is higher. However, it is found by the inventors that the ink absorbing rate by the Bristow's method does not agree always with the occurrence of the speckles and the banding. As a result of the investigation by the inventors, it is found that the speckles and the banding are difficultly formed so as to obtain a good image when the water absorbing property measured by the Bristow's method is controlled so as to satisfy the relation of Vb≧10 ml and Vb/Va≧0.7, and that the resistivity to light and to water can be considerably improved. Thus the present invention is attained.

The reason of correlation between the water absorbing property defined by the Bristow's method and the occurrence of the sprinkles and the banding is considered as follows even though it is not clearly understood yet. In the ink-jet printer, images are usually formed by plural times of scanning per unit area. Consequently, the ink by the later scanning is overlapped onto the dot formed by the scanning at earlier time. It is ideal for inhibiting the occurrence of the sprinkles and the banding that the absorption of the ink by the later scanning is not inhibit by the ink given by the earlier scanning. It is considered that the Vb represents the water absorption rate of paper imbibed with water and is collated to the ink absorption rate at the later scanning. In the invention, it is necessary to adjust to the condition of Vb≧10 ml, and preferably to Vb≧15 ml. When the Vb is within that range, the speckles and the banding are difficultly formed and a high quality image can be obtained. There is no particular limitation of the upper limit of the Vb; and it is ideal that the ink in an amount corresponding to the receiving capacity of the ink absorption layer is instantaneously absorbed. Besides, an ink absorption layer having a high glossiness and inhibited in the crack formation can be obtained by controlling the absorption capacity so as to be not more than 50 ml, preferably not more than 40 ml. Accordingly, the upper limit of the Vb is preferably not more than 50 ml, and is more preferably not more than 40 ml.

Besides, it has been found that the ratio of Vb/Va of the water absorption property defined by the Bristow's method influences to the resistivity to the light and water of the paper itself. It is considered that the lowering of the water absorption rate after the imbibing with water is caused by the space in the layer is reduced by swelling of the binder by lowering of the crosslinking structure of the layer. It is presumed that the cracking and the peeling off of the ink absorption layer tend to be caused by the synergistic effect of the lowering of the crosslinking structure and the degradation of the hydrophilic binder by light. For example, that phenomena tend to occur when the cross-linking agent such as boric acid is dissolved out by water. It is necessary to obtain the effects of the invention to control Vb/Va to not less than 0.7. The preferable range of Vb/Va is not less than 0.8 from the viewpoint of the resistivity to light and water. Although the upper limit of Vb/Va is not particularly limited, the ink absorptive layer having high glossiness and inhibited in the cracking can be easily obtained by adjusting the Vb/Va so as to be 7≧Vb/Va since the lower limit of Va is 7 ml and the upper limit of Vb is preferably not more than 50 ml.

The measurement of the Bristow value (or Bristow test measurement) is described below. The measurement of the Bristow value is carried out by employing an automatic scanning liquid absorption meter KM500win, manufactured by Kumagaya Riki Kogyo, Co., Ltd. The principle of the measurement is that the paper to be measured is swirlwise scanned by a head supplying a test liquid and the amount of the liquid transferred per unit time is measured. The transferred amount of the liquid is measured by monitoring the meniscus in a pipe connecting to the head. The principle of the measurement is the same as that of the liquid absorbability test described in J. TAPPI, “Paper and Pulp Test Method No. 15; Method for Determining the Liquid Absorbability of Paper and Board (Bristow's Method)”. In the invention, the test liquid employed for the measurement is water.

The silica microparticles usable in the present invention may be used either in the state of primary particle or the state forming secondary coagulated particles The average diameter of the silica microparticles employed in the invention is preferably not more than 0.25 μm, and is more preferably not more than 0.2 μm, for obtaining the high glossiness. The average diameter is preferably not less than 0.005 μm from the viewpoint of the stability in the production process when the particle is made very minute even though the lower limit of the average diameter is not particularly defined.

The average diameter of the silica microparticles is defined by the simple average or number average of 100 particles optionally selected from the observation of the cross section and the surface of the porous layer by an electronmicroscope. The diameter of the individual particle is defined by the diameter of a circle having the same area as the projection area of the particle.

The using amount of the silica microparticles is approximately from 3 to 30 g, preferably from 5 to 25 g, per square meter of the recording sheet. The suitable ink absorption property and the resistivity to cracking in the drying process are easily compatible within that range.

The silica microparticles to be used in the invention is made by a gas-phase method. The gas-phase method silica is one synthesized by a burning method from the silicon tetrachloride and hydrogen; for example, Aerogel series manufactured by Nihon Aerogel Co., Ltd., are available on the market.

The silica microparticles can be dispersed or crashed in a solvent, preferably in water, by a high pressure homogenizer, a high speed stirring dispersing machine, a sand mill or an ultrasonic dispersing apparatus. When the particles are each a high degree coagulated particle having an average diameter of not less than 1 μm such as the wet-method silica, it is particularly effective to reduce the content of the coarse particle having a diameter of not less than 10 μm in the size distribution after the crashing for obtaining the high glossiness and the high print density by raising the transparency of the ink receptive layer. For lowering the content of the coarse particles having a diameter of not less than 10 μm, crushing by a sand mill using zirconia beads of not more than 1.0 mm, preferably not more than 0.5 mm, is preferred.

Next, the hydrophilic binder relating to the invention is described. As the hydrophilic binder, ones known in the field of the art can be employed. Examples of the hydrophilic binder usable in the invention include gelatin (preferably acid process gelatin), poly(vinyl pyrrolidone) (preferably one having an average molecular weight of not less than 200,000), pulrane, poly(vinyl alcohol) and derivative thereof, poly(ethylene glycol) (preferably one having an average molecular weight of not less than 100,000), hydroxyethyl cellulose, dextran, dextrin and water soluble poly(vinyl butyral). These hydrophilic binders may be employed either individually or in combination of two or more kinds. The ratio of the silica microparticles to the hydrophilic binder is from 2:1 to 50:1, preferably from 2.5:1 to 20:1, and further preferably from 6:1 to 15:1, the effects of the invention can be easily obtained in that range.

For satisfying the water absorption property defined by the Bristow's method according to the invention, it is effective to reduce the swelling of the hydrophilic binder and to inhibit the variation of the swelling degree by water. The means for inhibiting the swelling include (1) a method in which the ratio of the silica microparticles to the hydrophilic binder is raised for enhancing the effect of the crosslinking between the hydrophilic binder and the silica microparticles, and (2) a method in which the hydrophilic binder is crosslinked by covalent bonds. The method (2) is preferred since the cracking of the ink absorption layer occurs difficultly. Examples of the crosslinking means by the covalent bond are described in JP-A, Nos. 2000-272224 and 2001-71633, in which poly(vinyl alcohol) is used as the hydrophilic binder and gallic acid, floroglucinol, melamine and glyoxal are used as the crosslinking agent. However, it has be found by the inventors that the practice of that method is not easy from the viewpoint of the property and the suitability to the production, since a heat treatment is necessary for satisfying the water absorption property defined by the Bristow's method according to the invention, a problem of coloration of the paper is caused and the curling tends to occur. In the invention, it is preferred to crosslink the hydrophilic binder by ionizing radiation.

Polymer compound capable of being crosslinked by the ionizing radiation relating to the invention is described below. The polymer compound crosslinkable by the ionizing radiation to be employed in the ink-jet recording sheet according to the invention is a water-soluble resin capable of crosslinking by the reaction caused by irradiation of the ionizing radiation such as UV rays and electron rays. The resin is water-soluble before the irradiation and is become substantially water-insoluble and forms a water-proof layer by increasing the molecular weight after the crosslinking reaction. Herein, the water-proof means that the remaining ratio in weight of the layer after immersion in warm water at 80° C. for 5 minutes is not less than 85%. That resin has hydrophilicity after the crosslinking reaction and holds sufficient affinity with the ink.

Listed as the resins are a saponification product of poly(vinyl acetate), poly(vinyl acetal), poly(ethylene oxide), poly(alkylene oxide), poly(vinyl pyrrolidone), polyacrylamide, hydroxyethyl cellulose, methyl cellulose, hydroxypropyl cellulose, derivatives of the above hydrophilic resins, at least one of copolymers of the above-described, and the above-described modified by a modifying group such as a photo-dimerization type, a photo-decomposition type, a photo-polymerization type, a photo-modification type and a photo-depolymerization type.

The ionic properties of the above-described modified resins are not specifically limited. However, nonionic polymers are preferably used by considering their high solubility with a cationic polymer and a multi-valent metal salt. The cationic polymer is preferably used for fixing the dye to give an improved water resistance and an improved bleeding resistance of the formed image.

As the resin modified by the photo-dimerization type modifying group, ones introduced with an diazo group, a cinnamoyl group, a styrylpyridinium group or a styrlquinolium group are preferred; and the resins capable of being dyed by an anionic dye after the photo-dimerization are preferred. Examples of that resin include resins each having a cationic group such as groups each having a primary through quaternary ammonium, for example, photosensitive resins (composition) described in JP-A Nos. 56-67309, 60-129742, 60-252341, 62-283339 and 1-198615, and resins each having a group such as an azide group which is converted to an amino group having cationic property by a hardening treatment, for example, the photosensitive resins (composition) described in JP-A No. 56-67309.

As the concrete crosslinking means for the polymer compound by ionizing radiation is described in JP-A No. 2002-160439, in which poly(vinyl alcohol), poly(ethylene oxide) and hydroxypropyl cellulose are used as the polymer compound and electron ray is employed as the ionizing radiation. It is found by the inventors that, when the hydrophilic resin is crosslinked by the electron ray, the amount of the electron ray becomes excessive to the hydrophilic resin and the solvent since the specific gravity of the silica microparticles is usually larger than that of the hydrophilic binder and that of the solvent. Consequently, the moisture in the coated layer is instantaneously evaporated to form bubbles so as to cause roughening of the surface. Furthermore, the irradiation amount is insufficient to the deeper portion of the coated layer. As a result of that, slop is formed in the density of the crosslink and a hardened layer is formed only at the surface of the coated layer. Consequently, the resistivity to the curing is considerably degraded.

Moreover, there is a problem that high concentration of oxygen in the atmosphere on the occasion of the electron ray irradiation disturbs the effect of the irradiation. It is necessary to hold the oxygen concentration at approximately not more than 400 ppm in the irradiation zone by replacing with inactive gas such as nitrogen and helium. That matter is not desirable for suitability to the production. JP-A No. 9-263038 proposes a method for gelling the coated layer before drying in which a coating liquid mainly composed of an inorganic sol and a monomer/oligomer hardenable by ionizing radiation is coated and the coated layer is irradiated by the ionizing radiation to harden the composition and dried to form an ink receptive layer.

However, a problem is newly raised that a layer having relatively high density and minute three dimensional crosslinks and the resistivity to the breaking caused by bending is degraded. The UV (ultra violet ray) radiation hardenable type monomer/oligomers generally have relatively low molecular weight and many of them give strong stimulus to the human skin. Therefore, there are many problems to be anxious from the viewpoint of bad influence of the unreacted component on the printed image quality and the safety. Almost of that compounds available on the market are not suitable for usual coating method using an aqueous coating liquid to coat the ink-jet receiving layer since the compounds have low hydrophilicity. Accordingly, the selectable range of the material is extremely narrowed.

Among the polymer compounds capable of being crosslinked by the UV radiation relating to the invention, polymer compounds having a plurality of side chains on the main chain and a polymerization degree of not less than 300 are preferred since the speckles and the banding difficultly occur in the recording sheet employing that polymer compound. The polymer compounds modified by the photo-dimerization type or photo-polymerization type modifying group are particularly preferred by which good properties as the binder such as the stability of the sensitivity and the polymer compounds themselves, and that the cracking is difficultly formed. The upper limit of the polymerization degree of the main chain of the polymer capable of being crosslinked by the UV radiation is not particularly defined. However, the handling suitability is inferior when the polymerization degree is excessively high since the viscosity of the coating liquid is become too high. Although the relation between the polymerization degree and the viscosity is different according to the kind of the polymer, the upper limit is approximately not more than 5,000, and is preferably not more than 4,000.

Preferable examples of the polymer compound crosslinkable by the UV radiation include photosensitive polymers having poly(vinyl alcohol) structure in which the following partial structures described in JP-A No. 56-67309 are included.

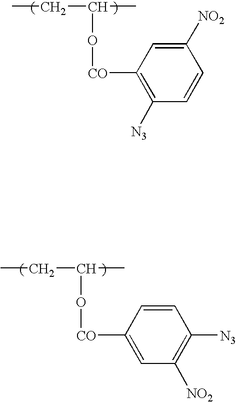

The concrete examples of the photosensitive resin are described in Examples 1 and 2, and the constituting components and the using ratio of the resin are described on page 2 of the above Patent Publication.

As other examples, the photosensitive resins described in JP-A No. 60-129742, which have the following partial structure in a poly(vinyl alcohol) structure.

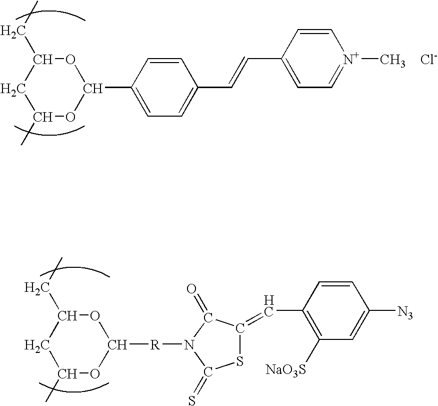

In the above formula, R is a di-valent bonding group.

As the photo-polymerization type modifying group, those represented by the following formula, described in JP-A No. 2000-181062, are preferred from the viewpoint of reactivity of the resin.

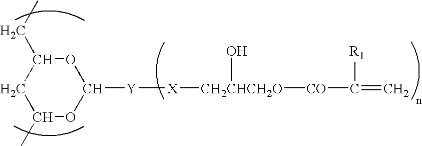

In the above formula, R₁ is a methyl group or a hydrogen atom, n is 1 or 2, x is —O— or —O—CO—(CH₂)ₘ, Y is an aromatic ring or a simple bond and m is an integer of from 1 through 6.

In the invention, a photo-initiator and a sensitizer may be preferably added. That compounds may be added in a state of dissolved in a solvent or dispersed in a medium or a state chemically bonded with the photosensitive resin.

As the photo-initiator and the photo-sensitizer, known ones in the field of the art may be employed without any limitation.

Although there is no limitation on the photo-initiator and the photo-sensitizer, the examples of them include the followings: benzophenone compounds such as benzophenone, hydroxybenzophenone, bis-N,N-dimethylaminobenzophenone, bis-N,N-diethylbenzophenone and 4-m4thoxy-4′-dimethylaminobenzophenone; tioxantone compounds such as thioxantone, 2,4-diethylthioxantone, isopropylthioxantone, chlorothioxantone and isopropoxychlorothioxantone; anthraquinone compounds such as ethylanthraquinone, benzanthraquinone, aminoanthraquinone and chloroanthraquinone; acetophenone comopounds; benzoin ether compounds such as benzoin methyl ether; 2,4,6-trihalomethyltriazine compounds; 1-hydroxycyclohexyl phenyl ketone, dimer of 2-(o-chlorophenyl)-4,5-diphenylimidazole, dimer of 2-(o-chlorophenyl)-4,5-di (m-methoxyphenyl)imidazole, dimer of 2-(o-fluorophenyl)-4,5-diphenylimidazole, dimer of 2-(o-methoxyphenyl)-4,5-diphenylimidazole, dimer of 2-(p-methoxyphenyl)-4,5-diphenylimidazole, dimer of 2-di(p-methoxyphenyl)-5-phenylimidazole, dimer of 2-(2,4-dimethoxyphenyl)-4,5-diphenylimidazole, dimer of 2,4,5-triarylimidazole, benzyl dimethyl ketal, 2-benzyl-2-dimethylamino-1-(4-morpholinophenyl)-butane-1-one, 2-methyl-1-[4-(methylthio)phenyl]-2-morpholino-1-propanone, 2-hydroxy-2-methyl-1-phenyl-propane-1-one, 1-[4-(2-hydroxyethoxy)-phenyl]-2-hydroxy-2-methyl-1-propane-1-one, 4-(2-hydroxyethoxy)-phenyl-(2-hydroxy-2-propyl)ketone, phenathlenequinone, 9,10-phenanthrenequinone, benzoin compounds such as methylbenzoin and ethylbenzoin; acrydine derivatives such as 9-phenylacrydine and 1,7-bis(9,9′-acrydinyl)heptane; bisacylphosphine oxide, and an mixture of the above-described. These compounds may be either employed individually or in combination.

The water-soluble initiators such as 1-[4-(2-hydroxyethoxy)-phenyl]-2-hydroxy-2-methyl-1-propane-1-one, 4-(2-hydroxyethoxy)-phenyl-(2-hydroxy-2-propyl)ketone, ammonium salt of thioxantone and ammonium salt of benzophenone are particularly preferable from the viewpoint of the mixing ability and the crosslinking efficiency.

An accelerator may be added additionally to the initiator. Examples of the accelerator include ethyl p-dimethylaminobenzoate, isoamyl p-dimethylaminobenzoate, ethanolamine, diethanolamine and triethanolamine.

In order to achieve an effect of the present invention, a preferable light source is a UV ray.

Employed as light sources, for example, are low, middle, or high pressure mercury lamps having an operating pressure of 100-1×10⁶ Pa, and metal halide lamps. In view of the wavelength range of light sources, a high pressure mercury lamp or a metal halide lamp is preferred, and of these, the metal halide lamp is particularly preferred. Further, it is preferable to arrange a filter to cut radiation of a wavelength of 300 nm or shorter. The output of lamps is preferably 400 W-30 kW, while illuminance is preferably 10 mW/cm²-1 W/cm². In the present invention, radiation energy is preferably 0.1-800 mJ/cm².

It is preferable that UV ray emitted from the light source does not contain UV ray of not more than 300 nm, the UV ray of not more than 300 nm is cut by a filter or the irradiation energy is not more than 500 mJ/cm². In that cases, decomposition of the mother nucleus of the ionizing radiation crosslinkable resin or that of the coexisted additive by the ionizing radiation can be avoided and the possibility of rising of problem of odor caused by the decomposition products can be considerably reduced. Particularly, when the irradiation energy is not less than 0.1 mJ/cm², high crosslinking efficiency is obtained so as to enhance the effects of the invention.

Illuminance of the UV ray irradiation is preferably from 1 mW/cm² to 1W/cm². When the illuminance is not more than 1W/cm², the hardening of the coated layer surface is suitable and the hardening of the deep portion of the layer is also suitable so that the situation can be avoided, in which the hardened layer is only formed at the surface of the coated layer. As a result of that, the hardness of the layer in the depth direction of the layer has good balance and the problem of curling is also difficultly raised.

When the illuminance is not less than 0.1 1W/cm², the scattering of light in the layer can be avoided and the crosslinking is sufficiently progressed so as that the effects of the invention can be obtained.

The presence of the suitable range for giving the same accumulative light amount (mJ/cm²) is caused by the variation of the transmittance of the light. The concentration distribution of the crosslinking reaction species is varied depending on the transmittance of the UV ray. When the illuminance of the UV ray is high, high concentration of the crosslinking reaction species is formed at the surface layer and a hard and minute layer is formed at the surface of the coated layer.

When the illuminance is in the suitable range, slack crosslinks are uniformly formed in the depth direction of the layer since the crosslinking degree of at the surface is low and the transmission of the light in the depth direction is high.

When the illuminance is too low, it is disadvantageous that the coast of the production equipment is made higher and the absolute light amount becomes insufficient by scattering of the UV ray by the coated layer since long irradiation time is necessary for giving the same accumulative irradiation.

Various additives can be employed in the ink absorption layer and another layer provided according to necessity of the ink-jet recording sheet relating to the invention other than the foregoing additives. Examples of that additive as the ink fixing agent include polyethyleneimine, polyallylamine, polyvinylamine, polyvinylamine, a condensate of dicyanediamide-polyalkylene-polyamine, a condensate of polyalkylene-polyamine-dicyanediamide ammonium salt, a condensate of dicyanediamide-flormaline, an addition polymer of epichlorohydrin-dialkylamine, a polymer of diallyldimethylammonium chloride, a copolymer of diallyldimethylammonium chloride-SO₂, polyvinylimidazole, a copolymer of poly(vinyl pyrrolidone)-vinylimidazole, polyvinylpryridine, polyamidine, chitosan, cationized starch, a polymer of vinylbenzyltrimethylammonium chloride, a polymer of (2-methacroyloxyethyl)trimethylammonium chloride, a polymer of dimethylaminoethyl methacrylate, cationic polymers described in “Kagaky Kogyo Jihou”, 15^{th} and 25^{th} October 1998, polyer dye mordants described in “Koubunshi Yakuzai Nyuumon” published by Sannyou Kasei Kogyo Co., Ltd., di-valent metal ions such as Mg²⁺, Ca²⁺ and Zn²⁺, tri-valent metal ions such as Al³⁺ and tetra- or more-valent water soluble metal ions such as such as Ti⁴⁺. The water-soluble poly-valent metal ions are each added in a state of salt such as sulfite, sulfate, nitrate, chloride, carbonate and p-toluenesulfonate. Water soluble inorganic polymers such as poly(aluminum chloride) may be employed as the water soluble poly-valent metal ion salt.

The cationic resin or the water soluble poly-valent metal ion may be added by a method in which that additive is directly added into the coated liquid to be coated or a method in which an aqueous solution of that additive is over-coated and dried on the recording medium after the coating and drying thereof.

Other than the above-described, the following various additives known in the field of the art may be added: anionic, cationic nonionic and amphoteric surfactants, boric acid and salts thereof, epoxy type crosslinking agents such as diglycidylethyl ether, ethylene glycol diglycidyl ether, 1,4-butanediol glycidyl ether, 1,6-doglycidylcyclohexane, N,N-diglycidyl-4-glycidyloxyaniline, sorbitol polyglycidyl ether and glycerol polyglycidyl ether, reactive halogen type crosslinking agents such as 2,4-dichloro-4-hydroxy-1,3,5-s-triazine, reactive vinyl type compounds such as 1,3,5-trisacryloyl-hexahydro-s-triazine and bisvinylsulfonylmethyl ether, aluminum alum, isocyanate type crosslinking agents, UV absorbents such as those described in JP-A Nos. 57-74193, 57-87988 and 62-261476, discoloration preventing agents such as those described in JP-A Nos. 57-74192, 57-87989, 60-72785, 61-146591, 1-95091 and 3-13376, fluorescent whitening agents such as those described in JP-A Nos. 59-42993, 50-52689, 62-280069, 61-242871 and 4-219266, pH controlling agents such as sulfuric acid, phosphoric acid, citric acid, sodium hydroxide, potassium hydroxide and potassium carbonate, anti-foaming agents, antiseptic agents, thickners, antistatic agents and matting agents.

The ink absorption layer of the ink-jet recording sheet according to the invention may be constituted by two or more layers. In this case, the constitution of these layers may be the same or different.

A water absorbable or non-absorbable support may be used as the support of the ink-jet recording sheet according to the invention. The non-absorbable support is preferred since wrinkles after the printing and difference of smoothness in the image are not formed so as that the high quality image can be obtained.

As the water-absorbable support, paper support is usually employed, and clothe and porous film are also employable.

Among them, paper support laminated by polyethylene resin on the both surfaces thereof is particularly preferred since the recorded image is near the quality of the photographic image and the high quality image can be obtained with low cost.

The support constituted by paper laminated by polyolefin resin on the both surfaces thereof is described below, which is the particularly preferable support in the invention.

Base paper employed for the paper support of the present invention is made employing wood pulp as a main raw material and if desired, synthetic pulp such as polypropylene or synthetic fiber such as nylon or polyester together with the aforesaid wood pulp. Employed as the wood pulp may be, for example, any of LBKP, LBSP, NBKP, NBSP, LDP, NDP, LUKP, or NUKP. However, it is preferable to use LBKP, NBSP, LBSP, NDP, or LDP, all of which comprise a relatively large amount of short fibers. However, the ratio of LBSP or LDP is preferably 10-70 percent by weight.

Preferably employed as the aforesaid pulp is chemical pulp (sulfate pulp and sulfite pulp) with minimal impurities. Further, useful is pulp which is subjected to a bleaching treatment to enhance whiteness.

It is possible to suitably incorporate into base paper sizing agents such as higher fatty acids or alkyl ketene dimers, white pigments such as calcium carbonate, talc, or titanium oxide, paper strengthening agents such as starch, polyacrylamide, or polyvinyl alcohol, optical brightening agents, moisture retention agents such as polyethylene glycol, dispersing agents, and softening agents such as quaternary ammonium.

The freeness of pulp used for paper making is preferably 200-500 ml under the specification of CSF, while regarding fiber length after beating, the sum of weight percent of 24 mesh residue and weight percent of 42 mesh residue, which are specified in JIS P 8207, is preferably 30-70 percent. Incidentally, weight percent of 4 mesh residue is preferably 20 weight percent or less.

The basic weight of base paper is preferably 50-250 g, and is particularly preferably 70-200 g, while the thickness of the base paper is preferably 40-250 μm.

Base paper may be given high smoothness employing calender finishing during or after paper making. The density of base paper is customarily 0.7-1.2 g/cm³ (in accordance with the method specified in JIS P 8118). Further, the stiffness of base paper is preferably 20-200 g under conditions specified in JIS P 8143.

Surface sizing agents may be applied onto the surface of the base paper. Employed as surface sizing agents may be the same ones as those which can be incorporated into the base paper.

The pH of base paper, when determined by the hot water extraction method specified in JIS P 8113, is preferably 5-9.

The polyolefin resin for covering the both surfaces of the paper is described below. Polyethylene, polypropylene, polyisobutylene and polyethylene area usable for that purpose, and polyolefins such as copolymers principally composed of propylene are preferable and polyethylene is particularly preferred.

The particularly preferred polyethylene is described below. The polyethylene to be used for covering the front and back surfaces of the paper is mainly low density polyethylene (LDPE) and/or high density polyethylene (HDPE), and LLDPE and polypropylene other than the above can be partially employed.

The polyolefin layer coated on the image receiving layer coating side is one improved in the opacity and the whiteness by addition of rutile type of anatase type titanium oxide is preferred. The content of the titanium oxide is approximately from 1 to 20%, and is preferably from 2 to 15%, of the polyolefin.

Tinting pigments having high heat resistivity and fluorescent whitening agents may be added to the polyolefin layer to control the whiteness of the background.

Examples of the usable tinting pigment include ultramarine blue, Prussian blue, cobalt blue, phthalocyanine blue, manganese blue, cerulean, tungsten blue, molybdenum blue and anthraquinone blue.

Examples of the usable whitening agent include dialkylaminocoumaline, bis-dimetylaminostilbene, bis-methylaminostilbene, 4-alkoxy-1,8-naphthalene dicarboxylic acid N-alkylimide, bis-benzoxazolylethylene and a dialkylstilbene.

The employing amount of the polyethylene is selected to optimize the curling under high and low humidity conditions after the provision of the back layer. Thickness of the polyethylene layer is usually from 15 to 50 μm on the ink absorption layer side and from 10 to 40 μm on the baking layer side. The ratio of the polyethylene on the front side to that on the back side is preferably decides so as to control the curling which is varied depending on the kind and the thickness of the ink receptive layer and the thickness of the raw paper. The ratio of the polyethylene of front/back is approximately from 3/1 to 1/3 in the layer thickness.

Further, it is preferable that the aforesaid polyolefin coated paper supports exhibit the following characteristics of (1) to (8).

(1) Tensile strength: Strength specified in JIS P 8113 is preferably 19.6-294 N in the longitudinal direction and 9.8-196 N in the lateral direction.

(2) Tear strength: Strength specified in JIS P 8116 is preferably 0.20-2.94 N in the longitudinal direction and 0.098-2.45 N in the lateral direction.

(3) Compression modulus of elasticity: ≧9.8 kN/cm²

(4) Opacity: Under measurement conditions specified in JIS P 8138, a preferable value is at least 80%, more preferably from 85 to 98%.

(5) Whiteness: Hunter whiteness specified in JIS P 8123 is preferably at least 80 percent. Further, when determined based on JIS Z 8722 (non-fluorescent objects) and JIS Z 8717 (containing fluorescent agents) and expressed by the color specification method specified in JIS Z 8730, L*, a* and b* are preferably 90-98, −5-+5, and −10-+5, respectively.

(6) Clark stiffness: A support having a Clark stiffness of from 50 to 300 cm³/100 in the conveying direction is preferable.

(7) The moisture content of the raw paper is preferably from 4 to 10% to the raw paper.

(8) The glossiness of the surface on which the ink receptive layer is provided is preferably from 10 to 90% in the mirror surface glossiness at 75°.

In the production of the ink-jet recording sheet of the present invention, a coating method employed for applying a porous layer liquid coating composition onto a support may suitably be selected from those known in the art. For example, preferably employed are a gravure coating method, a roller coating method, a rod bar coating method, an air knife coating method, a spray coating method, an extrusion coating method, a curtain coating method, and an extrusion coating method employing a hopper, described in U.S. Pat. No. 2,681,294.

The temperature of the coating liquid on the occasion of the coating is usually from 25 to 60° C., preferably from 35 to 50° C., particular preferably from 36 to 48° C. It is preferably for forming the uniform layer that the drying is carried out by blowing air of not less than 20° C. It is particular preferably that the temperature of the air is gradually raised after the air of not less than 20° C. is blown. The drying time is approximately not more than 10 minutes preferably not more than 5 minutes, even though the time is varied depending on the wet thickness of the coated layer.

For recording an image by the ink-jet recording sheet according to then invention, a recording method employing an aqueous kin is preferred.

The aqueous ink is a recording liquid comprising the following colorant, a liquid medium and another additive. As the colorant, water-soluble dyes such as directs dyes, acidic dyes, basic dyes, reactive dyes and edible dyes each known in the field of ink-jet printing and aqueous dispersion pigments are employable. The aqueous dispersion pigments are preferable which is superior in the image storage ability for the ink-jet recording sheet according to the invention since the recording sheet is characterized in that it has high the resistivity to water and light.

Examples of the solvent for the aqueous ink include alcohols such as methyl alcohol, iso-propyl alcohol, butyl alcohol, tert-butyl alcohol and iso-butyl alcohol; amides such as dimethylformamide and dimethylacetoamide; ketones and ketoalcohols such as acetone and diacetone alcohol; ethers such as tetrahydrofuran and dioxane; polyalkylene glycols such as polyethylene glycol and polypropylene glycol; polyvalent alcohols such as ethylene glycol, propylene glycol, butylene glycol, triethylene glycol, 1,2,6-hexanetriol, thiodiglycol, hexylene glycol, diethylene glycol, glycerol and triethanolamine; lower alkyl ethers of poly-valent alcohol such as ethylene glycol methyl ether, diethylene glycol methyl or ethyl, ether and triethylene glycol monobutyl ether. Among them, the poly-valent alcohols such as diethylene glycol, triethanolamine and glycerol, and the lower lakyl ether of poly-valent alcohol such as triethylene glycol monobutyl ether are preferable.

As another additive for the aqueous ink, for example, pH control agents, metal chelating agents, anti-mold agents, viscosity control agents, surface tension control agents, wetting agents, surfactants and antirust agents are cited.

The aqueous ink liquid preferably has a surface tension of from 0.025 to 0.06 N/m, more preferably from 0.03 to 0.05 N/m, at 20° C. for improving the wetting ability of the ink to the recording sheet.

Various kinds of method know in the field of the art is preferably used as the ink-jet recording method in the invention. The methods are described in detail, for example, in “Ink-jet Kiroku Gijutu no Doukou” (Trend of Ink-jet Recording Technology), edit. K. Nakamura, pub. Nihon Kagaku Johou Co., Ltd, 31^{st} March 1995.

### EXAMPLES

The invention is concretely described below referring examples, but the embodiment of the invention is not limited to the examples.

In the examples, percent is absolutely dried weight percent as long as a specific comment is not attached.

<Preparation of Dispersion 1>

Ten kilograms of gas-phase method silica having an average primary particle diameter of 12 nm and a specific surface area of 200 m²/g measured by BET method was dispersed by suction under a room temperature by a jet stream inductor mixer manufactured by Mitamura Riken Kogyo Co., Ltd., in 35 l of purified water and 435 ml of ethanol, and them made up to 43.5 l by purified water. The dispersion was referred to as Dispersion A1 which has a pH value of 2.8 and an ethanol content of 1% by weight.

After that, 40 g of a 28% aqueous solution of cationic polymer C-1 was added to 400 g of Dispersion Al and preliminary dispersed by a dissolver, and then a phosphate buffer was added so as to adjust the pH of the dispersion to 4.5. The dispersion was further dispersed by a sand mill dispersing machine for 30 minutes at a circumference speed of 9 m/second. The entire amount of the dispersion was made up to 360 ml to obtain almost transparent Dispersion-1. Resultant Dispersion-1 was filtered through a TCP-10 type filter manufactured by Advantex Toyo Co., Ltd.

Cationic polymer C-1 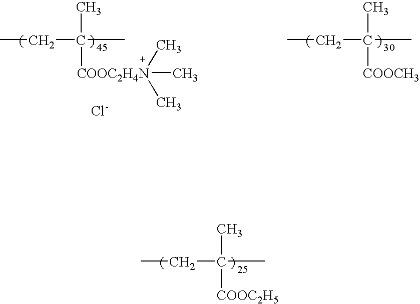
<Preparation of Dispersion-2>

Dispersion-2 was prepared in the same manner as in Dispersion-1 except that the phosphate buffer was replaced by 50 ml of an aqueous solution of 1.5 g of boric acid and 1.5 g of borax.

<Preparation of Dispersion-3>

Dispersion-3 was prepared in the same manner as in Dispersion-1 except that the gas-phase method silica was replaced by gas-phase method silica having an average primary particle diameter of 30 nm and a specific surface area of 50 m²/g measured by BET method, and the dispersing time was prolonged until the diameter of the dispersed particle was become 230 nm. The dispersed particle diameter was measured by a dynamic light scatter particle diameter measuring apparatus Zetasizer 1000HS, manufactured by Malbarn Co., Ltd.

<Preparation of Dispersion-4>

Dispersion-4 was prepared in the same manner as in Dispersion-3 except that the dispersion time by the sand mill was shortened so that the diameter of the dispersed particle was 270 nm.

<Preparation of Polymer Crosslinkable by Ionizing Radiation>

Poly(vinyl alcohol) having a polymerization degree of 3,000 and a saponification degree of 88% was reacted with p-(3-methacryloxy-2-hydroxypropyloxy)benzaldehyde referring JP-A No. 2000-181062 and a photo-polymerization initiator Kayacure QTX, manufactured by Nihon Kayaku Co., Ltd., was added in an amount of 1.8% by weight of the poly(vinyl alcohol). Thus an aqueous Solution B-1 of UV polymerizable poly(vinyl alcohol) derivative having a modifying ratio of crosslinking group of 1 mole-%, and the solid component content of the solution was 8%.

Then an aqueous Solution B-2 of UV polymerizable poly(vinyl alcohol) derivative was prepared in the same manner as in Solution B-1 except that the poly(vinyl alcohol) was replaced by poly(vinyl alcohol) having a polymerization degree of 300 and a saponification degree of 98 to 99%.

Further, an aqueous Solution B-3 of UV polymerizable poly(vinyl alcohol) derivative was prepared in the same manner as in Solution B-1 except that the poly(vinyl alcohol) was replaced by poly(vinyl alcohol) having a polymerization degree of 200 and a saponification degree of 98 to 99%.

<Preparation of Recording Sheet-1>

To 600 ml of Dispersion 1, 156 ml of Solution B-1 was gradually added while stirring at 40° C., and purified water added so as to make the total volume of the liquid to 1,000 ml. Thus a translucent coating liquid was obtained.

The above-obtained coating liquid was coated on polyethylene coated paper by a bar coater so that the wet thickness of the coated layer was 200 μm. The polyethylene coated paper was composed of raw paper of 170 g/m² which was laminated by polyethylene on the both surfaces; the polyethylene layer on the ink receptive layer side contained 8% of anatase type titanium oxide and a gelatin subbing layer of 0.05 g/m² was provided thereon, and a backing layer of 0.2 g/m² containing latex of polymer having a Tg of approximately 80° C. was coated on the opposite side. The coated layer was cooled for 20 second just after the coating in a cooling zone held at 0° C., and the coated layer was irradiated by UV ray from a metal halide lamp emitting light having a principal wavelength at 356 nm through a filter cutting wavelength range of not more than 300 nm, Filter 365 manufactured by Iwasaki Denki Co., Ltd. The illuminance of the irradiation was 100 mW/cm² and the energy amount was 40 mJ/cm². Then the coated layer was dried in a hot air type oven to prepare Recording sheet-2.

<Preparation of Recording Sheet-2>

Recording sheet-2 was prepared in the same manner as in Recording sheet-1 except that the adding amount of Dispersion-1 was changed to 510 ml and 90 ml of Dispersion-2 was further added.

<Preparation of Recording Sheet-3 through -7>

Recording sheet-3 through -7 were prepared in the same manner as in Recording sheet-2 except that the adding amount of Dispersion-1 and that of Dispersion-2 were changed as given in Table 1 and the amount of the UV polymerizable poly(vinyl alcohol) derivative B-1 was controlled so that the weight ratio (P/B) of the microparticles to the polyvinyl alcohol) derivative B-1 was made as shown in Table 1.

TABLE 1

| Sample | Dispersion-1 | Dispersion-2 | P/B |
|---|---|---|---|
| Recording sheet-1 | 600 ml | 0 ml | 7.0 |
| Recording sheet-2 | 510 ml | 90 ml | 7.0 |
| Recording sheet-3 | 390 ml | 210 ml | 7.0 |
| Recording sheet-4 | 300 ml | 300 ml | 7.0 |
| Recording sheet-5 | 90 ml | 510 ml | 7.0 |
| Recording sheet-6 | 0 ml | 600 ml | 7.0 |
| Recording sheet-7 | 300 ml | 300 ml | 8.5 |

<Preparation of Recording Sheet-8>

Recording sheet-8 was prepared in the same manner as in Recording sheet-1 except that Dispersion-3 was employed in place of Dispersion-1.

<Preparation of Recording Sheet-9>

Recording sheet-9 was prepared in the same manner as in Recording sheet-1 except that Dispersion-4 was employed in place of Dispersion-1.

<Preparation of Recording Sheet-10>

Recording sheet-10 was prepared in the same manner as in Recording sheet-1 except that the UV polymerizable polyvinyl alcohol) solution B-2 was employed in place of the UV polymerizable polyvinyl alcohol) solution B-1.

<Preparation of Recording Sheet-11>

Recording sheet-11 was prepared in the same manner as in Recording sheet-1 except that the UV polymerizable poly(vinyl alcohol) solution B-3 was employed in place of the UV polymerizable poly(vinyl alcohol) solution B-1.

Thus obtained Recording sheets 1 through 11 were subjected to the following evaluation.

<Evaluation of Occurrence of Speckles and Banding>

Green and blue solid images were printed by an ink-jet printer Novajet Pro and pigment inks, each manufactured by ENCAD Co., Ltd., on each of the recording sheets. The printed images were visually evaluated according to the following norms.

A: No speckle and banding were observed at all on the solid images.

B: Occurrence of the speckles and banding were slightly observed only by careful observation; no problem for the practical use at all.

C: Although the speckles and banding were observed on the solid images but the image quality brought almost no problem for the practical print.

D: Apparent speckles and banding were observed on the images; the quality of the images was not acceptable for the practical use.

<Evaluation of Resistivity to Water and Light>

The recording sheets were stood for 3 weeks at a place where directly exposed to sun light, wind and rain for all day. Then the layer surface of the recording face was visually observed.

A: Any irregular portion was not observed on the surface at all.

B: Although the glossiness was slightly lowered, there is no problem for the practical use.

C: The glossiness was lowered a little and small cracks were slightly observed.

D: The glossiness was considerably lowered and cracks were observed in places of the layer surface.

E: Cracks occur over the entire layer surface and the ink receptive layer was fallen off in places of the surface.

<Glossiness>

The glossiness at 75° was measured by an angle variable glossiness meter VGS-1001DP, manufactured by Nihon Denshiki Kogyo Co., Ltd. The value of the glossiness at 75° of not less than 45% gives satisfactory glossiness near the silver salt photograph for the practical view.

The above-obtained evaluation results, Vb and Vb/Va measured by the Bristow's method are listed in Table 2. The average diameters of the silica particles measured by the observation of the surface by an electronmicrometer of each of the recording sheets are also listed in Table 2.

TABLE 2

| | | | | Speck- | Resis- | | |
|---|---|---|---|---|---|---|---|
| | | | | les | tivity | | Silica |
| | | | | and | to water | | particle |
| | Re- | | Vb/ | Band- | and | Gloss- | di- |
| Sample | marks | Vb | Va | ing | light | iness | ameter |
| Recording | Inv. | 16.2 | 0.99 | A | A | 55% | 41 nm |
| sheet-1 | | | | | | | |
| Recording | Inv. | 11.3 | 0.83 | B | A | 54% | 43 nm |
| sheet-2 | | | | | | | |
| Recording | Comp. | 8.6 | 0.76 | D | B | 54% | 41 nm |
| sheet-3 | | | | | | | |
| Recording | Comp. | 6.3 | 0.42 | D | D | 55% | 39 nm |
| sheet-4 | | | | | | | |
| Recording | Comp. | 5.2 | 0.61 | D | D | 53% | 41 nm |
| sheet-5 | | | | | | | |
| Recording | Comp. | 4.6 | 0.40 | D | D | 53% | 42 nm |
| sheet-6 | | | | | | | |
| Recording | Inv. | 10.1 | 0.70 | C | C | 47% | 43 nm |
| sheet-7 | | | | | | | |
| Recording | Inv. | 11.0 | 0.95 | B | A | 49% | 235 nm |
| sheet-8 | | | | | | | |
| Recording | Inv. | 10.2 | 0.82 | C | A | 45% | 268 nm |
| sheet-9 | | | | | | | |
| Recording | Inv. | 12.8 | 0.99 | B | A | 52% | 41 nm |
| sheet-10 | | | | | | | |
| Recording | Inv. | 10.6 | 0.99 | C | A | 50% | 41 nm |
| sheet-11 | | | | | | | |

Inv.: Inventive
Comp.: Comparative

It is understood from Table 2 that, on the recording sheet according to the invention, the speckles and the banding is difficultly formed and a high quality image with high glossiness can be obtained, and the recording sheet has high resistivity to the problems caused by the light and water at the outdoor such as the occurrence of the cracks and layer peeling.

According to the invention, the ink-jet recording sheet excellent in the resistivity to the outdoor conditions can be provided by which a high quality image having high glossiness, and the speckle and banding are difficultly formed on the the image printed on the recording sheet.

1. An ink-jet recording sheet comprising a support having thereon an ink receptive layer containing silica microparticles made by a gas-phase method and a hydrophilic binder,
wherein the ink-jet recording sheet satisfies the following formula:
Vb≧10 ml; and
Vb/Va≧0.7,
Va and Vb are separate Bristow test measurements of an amount of water absorbed by the ink-jet recording sheet when the ink-jet recording sheet is contacted with water for 0.02 seconds,
Va being measured before treatment of said ink-jet recording sheet, and Vb being measured after treatment of said ink-jet recording sheet,
said treatment being:
(i) immersing said ink-jet recording sheet in water for 15 seconds; and then (ii) drying said ink-jet recording sheet such that said ink-jet recording sheet has a weight increase of less than 1 weight %.

2. The ink-jet recording sheet of claim 1, wherein the hydrophilic binder is a nonionic polymer which has been hardened by irradiation with ultra violet rays.

3. The ink-jet recording sheet of claim 1,
wherein the hydrophilic binder is a hydrophilic polymer having a degree of polymerization of 300 to 5000 and having a plurality of side chains bonded to a main chain in the molecule, and a cross-linking bond is formed between the sides chains by irradiation with ultra violet rays.

4. The ink-jet recording sheet of claim 1,
wherein each of the silica microparticles has an particle diameter of 0.005 to 0.25 μm.

5. The ink-jet recording sheet of claim 1,
wherein the support is non water-absorptive.
